(19) United States
(12) Patent Application Publication
(10) Pub. No.: US 2009/0037350 A1
(43) Pub. Date: Feb. 5, 2009

(54) METHOD FOR AUTOMATICALLY DISPLAYING ELECTRONIC INFORMATION RECEIVED BY A RECIPIENT IN A SORTED ORDER AND A COMMUNICATION SYSTEM AND/OR SYSTEM FOR EXCHANGING INFORMATION

(75) Inventor: ROBIN RUDAT, Karlsruhe (DE)

Correspondence Address: Henry M. Feiereisen;Henry M. Feiereisen, LLC, Suite 4714, 350 Fifth Avenue, New York, NY, 10118, US

(73) Assignee: Jubii IP Limited, London (GB)

(21) Appl. No.: 12/016,483

(22) Filed: Jan. 18, 2008

(30) Foreign Application Priority Data
Jan. 18, 2007 (EP) 07 001 008.7

(51) Int. Cl. G06F 17/20; G06F 15/16; G06F 7/06; G06F 17/30

(52) U.S. Cl. 706/11; 709/206; 707/7; 707/102; 707/E17.014; 707/E17.044

(57) ABSTRACT

Trustability and importance of incoming electronic information such as electronic messages and electronic data files are automatically calculated on the basis of the relationship between recipient and sender. The relationship comprises the communication behavior and the social connection between recipient and sender. For each incoming message it is checked whether predefined relationship items are fulfilled. Concrete relationship values are assigned to each fulfilled relationship item, enabling the calculation. The information about the behavior and the social connections are predominantly stored in a contact list not visible by the recipient and containing information of all contacts the recipient has communicated with during a predefined period of time. The electronic messages can be categorized into trusted and distrusted messages and in a trusted view they can be listed in rank order or marked-up with respect to importance.

### CROSS-REFERENCES TO RELATED APPLICATIONS

This application claims the priority of European Patent Application, Serial No. 07 001 008.7, filed Jan. 18, 2007, pursuant to 35 U.S.C. 119(a)-(d), the content of which is incorporated herein by reference in its entirety as if fully set forth herein.

### BACKGROUND OF THE INVENTION

The present invention relates to a method for displaying electronic information (e.g. electronic messages, electronic data files) received by a recipient in a sorted order. Furthermore, the invention relates to a communication system and/or system for exchanging information.

Nothing in the following discussion of the state of the art is to be construed as an admission of prior art.

Communication by electronic messages, in particular emails, across local area networks or worldwide networks, e.g. the internet, has significantly increased during the recent decade. Nowadays users of electronic message systems often have to face huge amounts of electronic messages, the administration of which is often time consuming and hardly acceptable. Moreover, important messages risk to be overseen in the bulk of spam, newsletters or other messages of minor importance.

Commonly known inboxes for electronic messages conventionally display incoming messages in accordance to the time of receipt. Alternatively, the messages can be listed (sorted) according to the sender or the size of the data transferred. However, these alternatives do not remedy the problem of lack of distinction between important and minor important messages. Approaches to sort the messages according to the given name of the subject are not reliable, since many users do not systemize the assignment of subjects or do not stick to the subject name once given.

It would therefore be desirable and advantageous to provide an improved method and a communication system, wherein the messages are displayed to obviate prior art shortcomings and to allow the recipient of the messages to more easily identify important messages and distinguish them from messages of minor importance.

### SUMMARY OF THE INVENTION

According to one aspect of the present invention, a method for displaying, in a sorted order, electronic messages received by a recipient, includes the steps of: defining at least one relationship variable characteristic of a relationship between the recipient and a sender of an electronic message, assigning a relationship value to the defined relationship variable, assessing for an incoming message the relationship between the sender and the recipient of the message based on the relationship value, and displaying the incoming message and at least a subset of previous messages from the sender in a sorted order based on the relationship value between the sender and recipient.

A method according to the invention allows to automatically display the incoming electronic messages according to the recipient's relationship to the sender. The selection of one or more relationship items out of a list of relationship items calculated by the communication system and possibly their respective significance is favorably under the discretion of the receiver (user of the system). After having selected the relationship item(s) and/or their significance there is no need for further activities of the receiver. Accordingly, the method and system of the invention allow a sorting of messages customized to the receiver's preferences and needs. Therewith it eases the administration of emails and reduces the risk of overseeing important messages.

Basis for the calculation of the sorted order is a comparison of the relationship between the recipient and sender of the message with predefined relationship items. The relationship items are preferably stored in the definition-memory module. The relationship items are suitable for assessing the relationship between the users of the system, e.g. behavior patterns (behavioral items) or social connection between sender and recipient. The behavioral pattern can be assessed e.g. by determining the length of time, which usually has lapsed before the recipient replies to the sender, or the frequency of communication between the sender and the recipient. Hence, the behavioral items are defined as parameters reflecting the actual activity in communication of the recipient with respect to the sender.

The information about the behavioral pattern—e.g. the frequency of contacts—between the recipient and a sender of a message is preferably available from the memory of a contact-memory module, e.g. of a server unit. The contact-memory module can be a special contact list.

According to another feature of the present invention, the behavioral items can be supplemented by relationship items, which are manually pre-determined by the recipient. For instance, the system can provide the option to classify the sender of a message as “trustable” or “important” or not. Other items, such as the listing of the sender's contact information in the recipient's address book can also be included in the assessment of the relationship and are encompassed by the term “relationship item”.

To each relationship item a certain relationship value, e.g. a numerical value, is assigned and stored as well.

Since the assessment of the relationship favorably depends inter alia on the recipient's behavior (see above), the relationship can change dynamically and therewith is in line with the current relationship between the recipient and the sender. Due to this flexibility and adjustability the inbox according to the present invention can be called “intelligent inbox”.

Each time an electronic message arrives, available information about the sender and about the communication behavior between recipient and the sender is identified and the respective relationship items are determined. For each relationship item the assigned relationship value is used for determining the category (sorted order) of the message and/or the rank order of the message within the sorted order. Hence, with each incoming message the sorted order and rank order is newly calculated and—if the case arises—adjusted.

To ensure clarity, it is necessary to establish the definition of several important terms and expressions that will be used throughout this disclosure:

The term “sorted order” relates to any order, classification or category resulting from predefined rules. For instance, messages categorized on the bases of relationship items can be displayed in different fields or different inboxes.

The term “rank order” relates to an order within a category (sorted order), whereas the position or the mark-up of a message within the sorted order depends on its priority, precedence or its relationship value(s).

The term “relationship item” relates to any parameter, which reflects the relationship between two users of a communication system.

The term “fulfilling a relationship item” means matching the relationship item with a certain communication behavior or a certain social connection.

The term “relationship value” relates to a numerical quantity or unique expression, assigned to a certain relationship item and allowing computer calculations.

The term “behavior item” relates to a relationship item with respect to communication behavior of an individual user of the system.

The term “definition-memory-module” relates to a computer module comprising a memory to store definitions for relationship items and/or relationship values assigned to the relationship items.

The term “Contact-memory module” relates to a computer module comprising a memory to store information about the recipient's communication, e.g. addresses of contacts or time of communication.

### BRIEF DESCRIPTION OF THE DRAWING

NONE

### DETAILED DESCRIPTION OF PREFERRED EMBODIMENTS

Other features and advantages of the present invention will be more readily apparent upon reading the following description of a currently preferred exemplified embodiment of the invention.

In a communication system a server unit and a plurality of user interface devices, e.g. personal computers, are configured to be connected to a common network, e.g. the internet or a local area network (LAN). The server unit comprises a database of registered users, also called “members”, whereby the server unit and the user interfaces are programmed in order to enable the exchange of electronic messages, e.g. emails, between the registered users among themselves or between registered users and non-registered users of the network. The server unit is programmed to provide a network portal, whereby for each registered user an inbox for incoming messages is supplied.

This embodiment of the invention is described in the view of the recipient of messages. The recipient is one of the registered users.

The intelligent inbox displays incoming messages such that the recipient is able to access messages quickly which are most likely the most important and trusted ones for him. Therefore, all incoming messages are rated towards trustability and importance. A basis for the rating is an individual contact list for each registered user of the communication system. This contact list is established on the server unit and contains information about every contact the recipient has communicated with during a predefined period of time. “Contacts” are individuals which may be members but need not to be members of the communication system.

The information available from the contact list comprises at least address, e.g. email address, number and time of communication items related to a certain contact. Additionally, the contact list can comprise information about markings of contacts or single messages with respect to trustability or importance. The contact list is automatically filled with the information and not visible to the recipient. Therewith the contact list differs from common known address books or buddy lists.

Hence, the recipient does not manually fill his contact list with selected entries and does not manipulate single information items contained therein. By default, entries in the list are deleted after a pre-selected period of time, e.g. 180 days. The recipient has the possibility to change the expiry time to another value, e.g. down to 30 days. Moreover, the contact list can be set up to allow a manual one time clean up by the recipient.

In the following, an example for managing and displaying incoming electronic information, here electronic messages, is given:

When a message arrives on the server unit it is first filtered by common spam filters. If a message is recognized as a spam, e.g. by the domain key, the message could be rejected for example. If the message is not spam, it is delivered to the recipient's inbox. It is possible to furthermore apply a content filter, to further check whether the message is suspicious. If the message is rated as suspicious, it is marked but delivered to the inbox.

For all messages arriving in the inbox the sorted or rank order is automatically calculated. The inbox is divided into separate views of different message categories. Only messages being rated as trusted are shown in a view for trusted messages (1^{st} category) whereas distrusted messages are shown in a view for distrusted messages (2^{nd} category). Within the trusted category the messages are displayed in a rank order with respect to importance. Rank order can mean that the most important message is on top of the list. Alternatively, the rank of the messages can be marked, e.g. with integers or color.

For calculation of the sorted or rank order of an incoming message it is checked against a set of pre-defined relationship items. These relationship items are based on the recipient's relationship to the contact. The relationship between recipient and contact comprises their communication behavior and social connections among themselves. A social connection is given e.g. by following cases:
a) The contact's address is part of the recipient's address book,
b) The contact's address is part of the recipient's contact list,
c) The contact's address is part of the address book or contact list of a third registered user which in turn is part of the recipient's address book or contact list.

In the following an example for trustability rating is given. Table 1 lists a set of relationship items in the left column and relationship values related thereto in the right column. With respect to trustability rating the relationship values are in the following named “trustability impact values”. Therewith, Table 1 gives an assigning-rule between relationship items and trustability impact values. Three different trustability impact values are given, namely “weak”, “normal” and “strong”.

TABLE 1

| Possible Relationship Item for Trustability Rating | Value |
|---|---|
| Recipient received messages from contact before. | Normal |
| More than a defined percentage of the messages which | Normal |
| the recipient received from that contact are read. | |
| Recipient sent message to contact within a defined | Strong |
| period. | |
| Recipient sent message to contact more than a defined | Normal |
| period ago. | |
| Contact is part of level 1 member's¹ contact list | Weak |
| Contact is part of level 2 member's² address book | Normal |

¹Level 1 member: A registered user who is part of the recipient's address book;
²Level 2 member: A registered user who is part of the recipient's contact list but not of his address book.

An example for calculation-rules which need to be fulfilled to reach the status “trusted” is that at least one relationship item with the trustability impact value “strong” is fulfilled or if at least three relationship items with trustability impact value “normal” are fulfilled. Moreover, two trustability impact values “weak” can substitute one trustability impact value “normal”.

The recipient cannot define or change the relationship items or the trustability impact values, respectively. However, it is foreseen that the recipient is able to influence the assigning-rule or the calculation-rules indirectly, e.g. by answering abstract questions, as for instance “How should your reading-behavior influence the rating, “strong”, “medium” or “weak”?”. These questions are internally related to the assigning-rule and calculation-rules. Therewith the answers lead to a change of the assigning-rules and/or the calculation-rule and, hence, possibly to a change of the electronic messages rated as “trusted”.

Furthermore, the recipient has the possibility to define rules, which lead to a higher trustability, if a message follows such rules.

Additionally, the recipient has the ability to rate a contact manually as “trusted” or “distrusted”, for example after having opened a message of the contact. This manual rating overwrites all applied calculations with respect to trustability to future messages of the sender.

To avoid cheating the recipient should not be able to see exact relationship items, trustability impact values, assigning-rules or calculation rules.

The relationship items defined in Table 1 consider the recipient's behavior as well as the behavior of other users or the content of their address books or their contact lists. In order to guarantee the privacy of each registered user it can be foreseen that he has the possibility to decide whether his own address book or contact list is used for other users' rating.

With the above method all incoming and not rejected messages are distributed to the trusted or distrusted view. In the trusted view the messages are ordered or marked-up in relation to their importance level. To automatically calculate the importance level all incoming messages are checked against a further predefined set of relationship items with assigned relationship values, whereby for the importance rating the relationship values are integers and in the following named “importance impact values”. Trustability and importance are calculated at the same time.

For importance calculation the importance impact values of every relationship item fulfilled by a message are summed up, the sum being decisive for a rank order. The message with the highest sum of importance impact values is most important, and positioned or marked accordingly. Table 2 shows an exemplary list of relationship items.

TABLE 2
Relationship Item for Importance Rating

First time of contact
Recipient never sent a message to contact
More than 1 week since last communication
Recipient received messages from contact but never opened them
Recipient initiated communication with contact within last 3 days
Contact replied to a message from only the recipient
Contact answered on a conversation the recipient received

In the above example of Table 2 no social connections between recipient and contact are considered for importance rating but solely behavior items, mainly considering the communication behavior between recipient and contact. As a matter of course, social connections can be considered as well.

As for trustability rating the recipient is able to modify the influence of the relationship items to importance rating without knowing the items in detail. Thus, the recipient has the possibility to change the relevancy of certain factors for the calculation of the importance from “weak” to “strong”, e.g. by means of a slide bar. For instance the following factors have to be considered:
a) the users' behavior against the sender,
b) the senders' behavior towards the user,
c) interaction between user and sender, and
d) the social connection between user and sender.

While changing the relevancy of the factors the assigning-rule and/or the calculation rules for importance calculation are changed and the new calculated list of messages is shown to the recipient, enabling him to recognize the most suitable setting.

Trustability and importance of messages are strongly correlated to trustability and importance of the sender of the message. Therefore, rating the trustability and importance of incoming messages is based on the evaluation of the sender. Hence, according to the evaluation of the sender messages is automatically categorized or rated into “trusted” and “distrusted” in order to display them in different views, e.g. different views of the address book or of a separate sender list. Within the trusted view the senders can be listed in a rank order with respect to importance.

The rank order of a list of messages and the rank order of the list of senders are calculated and therewith changed simultaneously. With each incoming message the lists are newly calculated.

Since for trustability rating as well as for importance ranking a certain amount of communication of the recipient is necessary, it is possible to disable the application of the described importance-rules until a predefined period of time in which the recipient has used the communication system or a certain amount of communication and/or contacts are in the contact list.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for displaying, in a sorted order, electronic messages received by a recipient, comprising the steps of:
defining at least one relationship variable characteristic of a relationship between the recipient and a sender of an electronic message;
assigning a relationship value to said defined relationship variable;
assessing for an incoming message the relationship between the sender and the recipient of said message based on the relationship value; and
displaying the incoming message and at least a subset of previous messages from the sender in a sorted order based on the relationship value between the sender and recipient.

2. The method of claim 1, characterized in that the relationship value is determined based on importance or trustability of the sender for the recipient.

3. The method of claim 1, further comprising establishing a contact list with contact information about contacts the recipient has communicated with.

4. The method of claim 3, wherein contact list is part of a contact-memory module and the contact information comprises data for verifying a relationship variable between the recipient and the sender.

5. The method of claim 3, wherein the contact information is stored for a predetermined time in the contact list and is subsequently deleted from said contact list.

6. The method of claim 3, wherein contact list is not visible to the recipient.

7. The method of claim 3, wherein the contact information can be deleted all at once by the recipient.

8. The method of claim 1, further comprising the steps of:
establishing trustability categories for received electronic messages,
assigning display attributes to each of the trustability categories,
automatically rating the trustability category of each electronic message based on the corresponding relationship value, and
displaying information of the display attributes assigned to the trustability category of the electronic messages.

9. The method of claim 8, further comprising the steps of defining the trustability categories at least as “distrusted” and “trusted”, and displaying only trusted messages.

10. The method of claim 1, further comprising the steps of defining a rank order for the messages, and automatically displaying at least some of the messages according to the defined rank order.

11. The method of claim 10, wherein the rank order of the messages is defined according to importance of the messages for the recipient.

12. The method of claim 1, wherein the relationship variable indicates whether or not the sender has been entered into an address book of the recipient.

13. The method of claim 1, wherein the relationship variable indicates whether or not the sender has been entered into an address book of a third person who has been entered into an address book of the recipient.

14. The method of claim 1, wherein the relationship variable indicates whether or not the sender has been entered into a contact list of the recipient.

15. The method of claim 2, wherein the relationship variable indicates if the sender is marked by the recipient with respect to importance and/or trustability.

16. The method of claim 1, wherein the relationship variable is based on a number of messages the recipient has sent to the sender within a predetermined time.

17. The method of claim 1, wherein the relationship variable is based on a frequency of mutual communication between the recipient and the sender within a predetermined time.

18. The method of claim 1, wherein the relationship variable is based on a number of incoming messages from the sender during a predetermined time.

19. The method of claim 1, wherein the relationship variable is based on a ratio of messages from the sender which are opened by the recipient.

20. The method of claim 2, wherein the relationship variable indicates whether or not at least one of the messages from the sender has been marked by the recipient with respect to the importance or trustability.

21. The method of claim 1, wherein the relationship variable is based on an elapsed time between different incoming messages received from or different outgoing messages sent to the sender, or both.

22. The method of claim 1, wherein the electronic messages are displayed in a sorted order with respect to trustability or importance of a sender, whereby the sorted order is automatically calculated on the basis of at least some of the relationship values.

23. The method of claim 1, wherein assignment rules used for assigning a relationship values to a relationship variable are not visible to the recipient.

24. The method of claim 1, wherein calculating rules for calculating the sorted order from the relationship values are not visible to the recipient.

25. The method of claim 23, wherein the recipient influences the assignment rules by answering an abstract question or by setting levels for certain predefined factors, or both.

26. The method of claim 24, wherein the recipient influences the calculating rules by answering an abstract question or by setting levels for certain predefined factors, or both.

27. The method of claim 25, wherein the messages displayed in a sorted order are automatically adjusting at the time the recipient influences the assignment rules.

28. The method of claim 26, wherein the messages displayed in a sorted order are automatically adjusting at the time the recipient influences the calculating rules.

29. A communication system comprising a server unit with a database of registered users and a plurality of user interface devices, the server unit and the plurality of user interface devices being configured to enable an exchange of electronic messages in a network, wherein the communication system is configured to display, in a sorted order, electronic messages received by a recipient, by
defining at least one relationship variable characteristic of a relationship between the recipient and a sender of an electronic message;
assigning a relationship value to said defined relationship variable;
assessing for an incoming message the relationship between the sender and the recipient of said message based on the relationship value; and
displaying the incoming message and at least a subset of previous messages from the sender in a sorted order based on the relationship value between the sender and recipient.
